(19) United States
(12) Patent Application Publication
(10) Pub. No.: US 2010/0128891 A1
(43) Pub. Date: May 27, 2010

(54) REPULSION-TYPE MAGNETIC CIRCUIT AND SPEAKER DEVICE

(75) Inventors: Hayami Kondo, Yamagata (JP); Koji Matsumoto, Yamagata (JP); Yoshimi Kudo, Yamagata (JP); Hiroyuki Dohi, Tendo-shi (JP)

Correspondence Address: YOUNG & THOMPSON, 209 Madison Street, Suite 500, Alexandria, VA, 22314, US

(73) Assignees: PIONEER CORPORATION, Tokyo (JP); TOHOKU PIONEER CORPORATION, Tendo-shi (JP)

(21) Appl. No.: 12/596,928

(22) PCT Filed: Apr. 24, 2007
(86) PCT No.: PCT/JP2007/058822

§ 371 Date: Nov. 30, 2009

(51) Int. Cl. H04R 1/02; H01F 7/02; H04R 9/06

(52) U.S. Cl. 381/86; 335/306; 381/386; 381/412

(57) ABSTRACT

A repulsive-type magnetic circuit prevents deterioration of magnetic characteristic of magnets due to heat accumulation, and includes: a magnet and plural magnets arranged such that matching poles of the magnet and each of the plural magnets confront each other; a yoke; a pole piece; and a top plate. The pole piece is above the yoke. The top plate is above the pole piece. The magnet is between the yoke and the pole piece. The plural magnets are arranged between the pole piece and top plate. Joule heat generated by the voice coil is hardly propagated, as radiant heat, to one of the plural magnets on the side near the top plate. Accordingly, the temperature of the magnet on the top plate side hardly rises even if radiant heat continuously propagates to the pole piece. This prevents demagnetization of each of the plural magnets, and deterioration of the magnetic characteristics thereof.

### TECHNICAL FIELD

The present invention relates to a repulsive-type magnetic circuit for a speaker device.

### BACKGROUND TECHNIQUE

Conventionally, there is known a speaker device including a repulsive-type magnetic circuit in which plural magnets are arranged such that the same poles of the magnets confront each other, with sandwiching a pole piece (also called as a center plate) therebetween, to generate a repulsive magnetic field in a magnetic gap between an outer peripheral part of the pole piece and an inner peripheral part of a yoke (For example, see. Patent Reference-1 and Patent Reference-2).

The magnetic circuit for the speaker device disclosed in Patent Reference-1 includes a bottom plate; a first rare earth magnet arranged on the bottom plate; a pole piece arranged on the first rare earth magnet; a second rare earth magnet arranged on the pole piece; a plate arranged on the second rare earth magnet; and a yoke provided to surround the first rare earth magnet and the pole piece. The first and the second rare earth magnets, having large coercive force and energy product, are arranged such that the same poles confront each other with respect to the upper and the lower surfaces of the pole piece.

Also, the speaker device disclosed in Patent Reference-2 includes a repulsive-type magnetic circuit in which two magnets are arranged such that the same poles confront each other, a metal plate is positioned between the confronting two magnets, a voice coil is arranged such that the wound coil part is positioned to confront the outer peripheral surface of the metal plate, and an outer ring is arranged at the outer circumferential side of the voice coil and at the position to confront the metal plate. At the outer peripheral surface of the outer ring, a short ring to short-circuit eddy current generated in the repulsive-type magnetic circuit is provided.

Patent Reference-1: Japanese Patent No. 3106338

Patent Reference-2: Japanese Patent Application Laid-Open under No. 2003-163992

### DISCLOSURE OF INVENTION

### Problem to be Solved by the Invention

In the speaker device including the magnetic circuit for speaker device according to Patent Reference-1, when current is applied to the voice coil, the voice coil generates Joule heat, the Joule heat becomes radiant heat and is propagated to the pole piece, then to the first and the second rare earth magnets, further to the bottom plate and the plate. Thereby, the radiant heat propagated to the first and the second rare earth magnets is radiated by the bottom plate and the plate, respectively.

However, there is such a problem in the speaker device that, if the voice coil is driven for a long time, the radiant heat is accumulated in each of the first and the second rare earth magnets, each of the first and the second rare earth magnets is demagnetized due to the accumulated heat (for example, equal to or higher than 80 C.°, and thereby the magnetic characteristic of each of the first and the second rare earth magnets is deteriorated. Particularly, since a rare earth magnet is used as the magnet in the speaker device, such a deficiency remarkably appears.

In addition, in such a speaker device, when current is applied to the voice coil, a magnetic flux (called “second magnetic flux”) from the plate to the pole piece is generated by the current. There is such a problem that current distortion easily occurs in the area where the second magnetic flux is generated.

The above are examples of the problem to be solved by the present invention. It is an example of an object of the invention to mainly prevent the deterioration of magnetic characteristic of the magnet due to the accumulated heat of the magnet and the current distortion in the speaker device including a repulsive-type magnetic circuit.

### Means for Solving the Problem

According to the invention of claim 1, a repulsive-type magnetic circuit comprises: a magnet and plural magnets arranged such that same pole of the magnet and each of the plural magnets confront each other; a yoke; a pole piece; and a top plate, wherein the pole piece is arranged above the yoke, wherein the top plate is arranged above the pole piece, wherein the magnet is arranged between the yoke and the pole piece, and wherein the plural magnets are arranged between the pole piece and the top plate.

### BRIEF DESCRIPTION OF THE DRAWINGS

FIG. 1 is a sectional view of a speaker device including a repulsive-type magnetic circuit according to an embodiment of the present invention;

FIGS. 2A and 2B are sectional views of main part of repulsive-type magnetic circuit according to the embodiment and a comparative example, respectively;

FIG. 3 is a sectional view of a speaker device including a repulsive-type magnetic circuit according to a modified example-1;

FIG. 4 is a graph showing a relation between sound pressure level of the speaker device including the repulsive-type magnetic circuit according to the modified example-1 and frequency;

FIG. 5 is a graph showing a relation between sound pressure level of the speaker device including the repulsive-type magnetic circuit according to the comparative example and frequency;

FIGS. 6A to 6C are sectional views of a speaker device including a repulsive-type magnetic circuit according to a modified example-2 of the present invention; and

FIGS. 7A and 7B are sectional views of speaker devices including a repulsive-type magnetic circuit according to other modified examples of the present invention.

### BRIEF DESCRIPTION OF REFERENCE NUMBERS

1,1z Yoke
1a Under plate
1b Outer peripheral part
2,4,5 Magnet
3 Pole piece
6 Top plate
7 Plate
15 Metal layer
30,30x,30y Magnetic circuit
31 Vibrating body
32 Supporting body
33 Magnetic gap
100,100x,100y Speaker device

### DETAILED DESCRIPTION OF THE PREFERRED EMBODIMENTS

According to one aspect of the present invention, there is provided a repulsive-type magnetic circuit comprising: a magnet and plural magnets arranged such that same pole of the magnet and each of the plural magnets confront each other; a yoke; a pole piece; and a top plate, wherein the pole piece is arranged above the yoke, wherein the top plate is arranged above the pole piece, wherein the magnet is arranged between the yoke and the pole piece, and wherein the plural magnets are arranged between the pole piece and the top plate. In a preferred example, a speaker device can be formed with the above repulsive-type magnetic circuit.

Now, assuming a speaker device of a comparative example including a repulsive-type magnetic circuit in which, not the plural magnets, but a single magnet is arranged between the pole piece and the top plate in this repulsive-type magnetic circuit, the voice coil generates Joule heat when current is applied, and the Joule heat is propagated as the radiant heat to the pole piece, then to the plural magnets arranged respectively on upper and lower sides of the pole piece, then further to the top plate. Thereby, the radiant heat propagated to each of the magnets is radiated by the top plate. Also, the Joule heat generated by the voice coil is propagated as the radiant heat to the pole piece, then to the plural magnets arranged respectively upper and lower sides of the pole piece, then further to the yoke. Thereby, the radiant heat propagated to each of the magnets is radiated by the yoke.

However, if the voice coil is driven for a long time in the comparative example, the radiant heat is accumulated in each of the magnets, and each of the magnets is demagnetized due to the accumulated heat (e.g., equal to or higher than 80 C.°). Therefore, there is a problem that the magnetic characteristic of each of the magnet is deteriorated. Particularly, in a case of using a rare earth magnet as each of the magnets in the comparative example, the deficiency remarkably appears.

In this point, in the above repulsive-type magnetic circuit, the magnet and plural magnets are arranged such that same pole of the magnet and each of the plural magnets confront each other. The repulsive-type magnetic circuit includes a yoke, a pole piece, and a top plate. The pole piece is arranged above the yoke. The top plate is arranged above the pole piece. The magnet is arranged between the yoke and the pole piece, and the plural magnets are arranged between the pole piece and the top plate.

By arranging the plural magnets in a divided manner between the pole piece and the top plate, the radiant heat is hardly propagated to one of the plural magnets arranged near the top plate. Namely, in the repulsive-type magnetic circuit, the plural magnets are arranged in the divided manner between the pole piece and the top plate so as to prevent that the magnetic characteristic of the magnets arranged between the top plate and the pole piece are deteriorated by the radiant heat propagated via the pole piece.

As a result, when the voice coil is driven for a long time, even if the radiant heat is continuously propagated to the pole piece, the temperature of the magnet arranged on the top plate side hardly rises. Thus, the demagnetization of the plural magnets due to the temperature rise can be prevented, and the deterioration of the magnetic characteristic of the plural magnets can be prevented. Further, even if the magnet arranged on the pole piece side is demagnetized due to the radiant heat and its magnetic characteristic is deteriorated, it is possible to minimize the deterioration of the magnetic characteristic of the magnets arranged between the pole piece and the top plate, as a whole. Furthermore, if there exists adhesive for jointing the plural magnets between the plural magnets, it can be prevented that the radiant heat is propagated to the magnet arranged on the top plate side.

Similarly, by arranging the magnets in a divided manner between the pole piece and the yoke, it can be prevented that the radiant heat is propagated to the magnet arranged on the yoke side, as described above.

In one mode of the repulsive-type magnetic circuit, a metal layer is arranged between the plural magnets.

In the above-described comparative example, when the current is applied to the voice coil, the magnetic flux from the top plate to the pole piece (referred to as “second magnetic flux”) is generated by the current. There is such a problem that the current distortion easily occurs in the area where the second magnetic flux is generated.

In this point, according to this mode, the metal layer is arranged between the plural magnets. By this, the induced current is generated in the metal layer, and it can be prevented that the voice coil in which the current flows generates the current distortion in the repulsive-type magnetic circuit.

In a preferred example, it is preferred that at least one of the materials forming the metal layer has a thermal conductivity larger than that of the magnet. Also, it is preferred that at least one of the materials forming the metal layer has an electric conductivity larger than that of the magnet. In this way, by making at least one material forming the metal layer arranged between the magnets by a layer of metal material (including alloy), such as aluminum, nickel, etc., having large thermal conductivity or large electric conductivity, the generation of the induced current is enhanced. By the generation of the induced current, it can be prevented that the current distortion occurs in the repulsive-type magnetic circuit. However, it is required that the metal layer is appropriately thin so that it does not obstruct the passage of the magnetic flux between the plural magnets. Therefore, it is preferred that the thickness of the metal layer 15 is approximately 15 μm, for example.

In another mode of the repulsive-type magnetic circuit, a metal layer is formed on a surface of at least one of the plural magnets. By this, the induced current is generated in the metal layer, and it can be prevented that the voice coil in which the current flows generates the current distortion in the repulsive-type magnetic circuit. Particularly, by forming the metal layer at the external surface of at least one of the plural magnets, the thermal conductivity becomes large at the surface of the at least one of the plural magnets, and the heat accumulation in the at least one of the plural magnets can be prevented. Further, since many heat paths are formed from the pole piece to the top plate, the path is long and the surface area of the repulsive-type magnetic circuit contacting the outside becomes large, the heat is easily radiated as the above-mentioned radiant heat, and the temperature of the repulsive-type magnetic circuit hardly rises. In addition, since the pole piece and the top plate are thermally connected to each other, there are such advantages that the heat propagation from the pole piece to the magnets can be prevented, that the heat can be easily propagated to the top plate and that the heat can be easily radiated from the top plate as the radiant heat.

In still another mode of the repulsive-type magnetic circuit, an outside diameter of the top plate is smaller than an outside diameter of the pole piece.

In the above comparative example, the direction of the magnetic flux near the top plate is substantially opposite to the direction of the magnetic flux near the pole piece. Therefore, in view of magnetization, there is such a problem that large damping force acts on the vibration of the voice coil and sufficient vibration cannot be obtained. Further, in the above comparative example, there is such a problem that the Joule heat generated by the voice coil is propagated as the radiant heat to the top plate, then to the magnet arranged on the lower side of the top plate, the temperature of the magnet rises to demagnetize the magnet, and the magnetic characteristic thereof is deteriorated.

In this point, since the outside diameter of the top plate is smaller than the outside diameter of the pole piece, the damping force acting on the voice coil can be diminished by the leak magnetic flux generated near the top plate (the leak magnetic flux generated in a direction opposite to the direction of the magnetic flux generated near the pole piece). Therefore, the magnitude corresponding to the applied current can be given to the voice coil, and the diaphragm can be largely vibrated.

In addition, since the outside diameter of the top plate is smaller than the outside diameter of the pole piece, the distance between the voice coil and the top plate can be large. By separating the top plate from the voice coil in this manner, it can be prevented that the radiant heat is propagated to the top plate. Thereby, the temperature rise of the magnet arranged on the lower side of the top plate can be prevented. The demagnetization of the magnets due to the temperature rise thereof can be prevented, and the deterioration of the magnetic characteristic of the magnets can be prevented.

In still another mode of the repulsive-type magnetic circuit, the yoke includes: an under plate; and an outer peripheral part surrounding the under plate. The magnet, the pole piece, the plural magnets and the top plate are arranged on the under plate in this order, and a plate is arranged on the outer peripheral part of the yoke.

In the above comparative example, the magnetic flux is generated from the pole piece to the yoke (the magnetic flux is closed). In the area where the closed magnetic flux exists, there is a problem that the current distortion easily occurs. Also, in the comparative example, there is a problem that, since the Joule heat of the voice coil is propagated as the radiant heat to the yoke, the temperature of the magnet arranged on the yoke rises, the magnet is demagnetized, and the magnetic characteristic is deteriorated. If the magnet exists on the lower side of the pole piece, the heat from the pole piece is also propagated to the magnet to further rise the temperature of the magnet, the magnet is demagnetized, and the magnetic characteristic thereof is further deteriorated.

Now, it is assumed an another comparative example which is based on the configuration of the above-described comparative example and which includes a repulsive-type magnetic circuit in which the outer peripheral part of the yoke has a cylindrical shape and the upper surface of the outer peripheral part of the yoke is positioned substantially at the same height as the upper surface of the pole piece. In that comparative example, the directions of the magnetic flux on the upper side of the magnetic gap (i.e., in the acoustic radiation direction) and on the lower side of the magnetic gap (i.e., in the direction opposite to the acoustic radiation direction) are not symmetrical with each other. Therefore, in this comparative example, there is such a problem that the vibration direction of the voice coil is different through the magnetic gap and abnormal vibration easily occurs. Further, in this comparative example, there is such a problem that, since the magnitude of the electromagnetic force (Lorentz force) acting on the voice coil is different through the magnetic gap, desired magnitude of vibration cannot be obtained and good acoustic characteristic cannot be obtained.

In this point, in the repulsive-type magnetic circuit of this mode, the yoke includes the under plate and the outer peripheral part surrounding the under plate. The magnet, the pole piece, the plural magnets, and the top plate are arranged on the under plate in this order. The plate formed separately from the yoke is arranged on the outer peripheral part of the yoke.

By dividing the yoke into plural members (plate and the yoke itself), namely, into the plate forming the magnetic gap and the yoke supporting the plate, an induced current can be generated in the plate. Therefore, the generation of the above-mentioned second magnetic flux can be prevented, and the generation of the current distortion in the speaker device including the repulsive-type magnetic circuit can be prevented.

Further, by arranging the plate on the yoke, the radiant heat is hardly propagated from the plate to the yoke. Thereby, the temperature rise of the magnet arranged between the yoke and the pole piece can be prevented. As a result, it can be prevented that the magnet is demagnetized due to the temperature rise of the magnet, and hence it can be prevented that the magnetic characteristic of the magnet is deteriorated.

Further, in this mode, by extending the plate from the inner peripheral part of the yoke toward the pole piece, the directions of the magnetic flux on the upper side of the magnetic gap (i.e., in the acoustic radiation direction) and on the lower side of the magnetic gap (i.e., in the direction opposite to the acoustic radiation direction) become substantially symmetrical with each other. Therefore, the vibration direction and vibration magnitude of the voice coil as well as the driving force acting on the voice coil become substantially symmetrical through the magnetic gap, and hence the abnormal vibration as well as the deterioration of the vibration and the acoustic characteristic can be prevented. Further, by increasing the thickness of the plate or extending the inner peripheral part of the plate toward the bottom part of the yoke, the area in which the magnetic flux acts on the voice coil, i.e., the width of the magnetic gap (in the vibration direction side) becomes large even if the voice coil largely vibrates. Thus, the driving force of the repulsive-type magnetic circuit becomes constant irrespective of the magnitude, and the distortion of the reproduced sound can be diminished.

In still another mode of the repulsive-type magnetic circuit, a height from a bottom of the yoke to the upper surface of the plate is higher than a height from the bottom of the yoke to an upper surface of the pole piece.

By making the height from the bottom part of the yoke to the upper surface of the plate higher than the height from the bottom part of the yoke to the upper surface of the pole piece as described above, the distance between the plate and the top plate can be reduced. By positioning the plate closer to the top plate in this way, Permeance Coefficient (a value obtained by dividing the magnetic flux density by the magnetic flux) can be large. Therefore, the operation point of the plural magnets arranged between the top plate and the pole piece can be large. Meanwhile, there is a measure of making the magnets thicker in order to make the operating point of the plural magnets large. However, there is a demerit that the magnetic flux density in the magnetic gap does not become so large if the thickness of the plural magnets is increased. Therefore, the measure of positioning the plate closer to the top plate is more preferable than the measure of making the plural magnets thicker, because the magnetic flux density of the magnetic gap can be further increased.

In still another mode of the repulsive-type magnetic circuit, each of the plural magnets includes at least a ferrite magnet and a rare earth magnet.

In this configuration, if the magnetic characteristic of the rare earth magnet constituting each of the plural magnets is deteriorated due to the accumulation of the radiant heat, the deterioration of the magnetic characteristic of the plural magnets as a whole is smaller in comparison with the case in which the whole of the plural magnets is rare earth magnet. Therefore, the deterioration of the acoustic characteristic of the speaker device can be minimized.

In still another mode of the repulsive-type magnetic circuit, a plurality of the magnets are provided between the yoke and the pole piece.

By providing a plurality of magnets in a divided manner between the yoke and the pole piece, it can be prevented that temperature of the plurality of magnets arranged between the yoke and the pole piece rises due to the radiant heat propagated via the pole piece. As a result, the demagnetization of the plurality of magnets due to the temperature rise of those magnets can be prevented, and the deterioration of the magnetic characteristic of each of the plurality of magnets can be prevented.

### Embodiments

Preferred embodiments of the present invention will be described below with reference to the attached drawings.

[Configuration of Speaker Device]

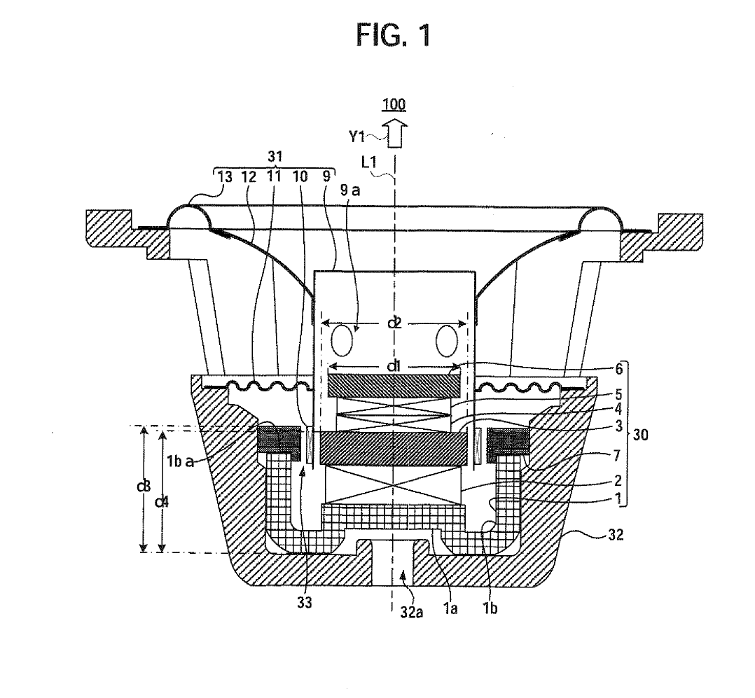

First, the configuration of a speaker device including a repulsive-type magnetic circuit according to an embodiment of the invention will be described with reference to FIG. 1. FIG. 1 is a sectional view of a speaker device 100 including a repulsive-type magnetic circuit 30 according to the embodiment of the invention, cut at the position passing through the center axis L1 thereof.

The speaker device 100 includes the repulsive-type magnetic circuit 30, a vibrating body 31 and a supporting body 32.

### (Configuration of Repulsive-Type Magnetic Circuit)

The repulsive-type magnetic circuit 30 includes a yoke 1, a magnet 2, a pole piece 3, plural magnets 4 and 5, a top plate 6 and a plate 7, as constitutional elements. The magnet 2 and the plural magnets 4 and 5 are arranged such that the same poles (N-pole or S-pole) confront each other.

The yoke 1 includes an under plate 1a having disc shape and an outer peripheral part 1b having substantially cylindrical shape. The outer peripheral part 1b is formed integrally with the under plate 1a, and surrounds the under plate 1a, the magnet 2 and a part of the pole piece 3. The magnet 2 has a disc shape, and is arranged on the under plate 1a of the yoke 1. The pole piece 3 has a disc shape, and is arranged on the magnet 2. The magnet 4 has a disc shape, and is arranged on the pole piece 3. The magnet 5 has a disc shape, and is arranged on the magnet 4. In a preferred example, each of the plural magnets 4 and 5 includes at least a ferrite magnet and a rare earth magnet. The top plate 6 has a disc shape, and is arranged on the magnet 5. The outside diameter d1 of the top plate is smaller than the outside diameter d2 of the pole piece 3. The plate 7 has an annular shape extending (or projecting) inside (the center axis L1 side) of the inner wall of the outer peripheral part 1b of the yoke 1, and is arranged on the outer peripheral part 1b of the yoke 1. In a preferred example, the plate 7 is formed of the same material as the yoke 1. The height d3 from the bottom of the yoke 1 to the upper surface of the plate 7 is higher than the height from the bottom of the yoke 1 to the upper surface of the pole piece 3.

In the repulsive-type magnetic circuit 30 having the above configuration, the magnetic gap 33 is formed between the plate 7 and the pole piece 3, and a repulsive magnetic field is generated by the magnet 2 and the plural magnets 4 and 5 in the magnetic gap 33.

(Configuration of Vibrating Body)

The vibrating body 31 includes a voice coil bobbin 9, a voice coil 10, a damper 11, a diaphragm 12 and an edge 13, and the configuration of each of those constitutional elements are as follows.

The voice coil bobbin 9 has a cylindrical shape, and is arranged to surround each of the pole piece 3, the plural magnets 4 and 5, and the top plate 6. The voice coil bobbin 9 has openings 9a for radiating the heat generated in the repulsive-type magnetic circuit 30 to the outside of the speaker device 100.

The voice coil 10 is wound around the outer circumferential surface of the voice coil bobbin 9 at its lower end part, and is positioned within the magnetic gap 33. The voice coil 10 has a pair of plus/minus lead wires (not shown). The plus lead wire is an input wire of an L (or R) channel signal, and the minus lead wire is an input wire of a ground (GND) signal. Each of the pair of the plus/minus lead wires is connected to each of the speaker terminals (not shown) attached to appropriate positions of the supporting body 32 described later, respectively. Each of the speaker terminals is electrically connected to each of the pair of output wires drawn out of the amplifier side.

The damper 11 has a function of elastically supporting the voice coil bobbin 9. The damper 11 has an annular shape, and is formed with a plurality of concentric corrugations. The inner circumferential edge part of the damper 11 is attached to the outer circumferential surface of the voice coil bobbin 9 around its center part, and the outer peripheral edge part of the damper 11 is attached to the supporting member 32, described later, around its center part.

The diaphragm 12 has a conical shape, and has a function of radiating sound wave corresponding to the audio signal inputted to the voice coil 10. The inner circumferential edge part of the diaphragm 12 is attached to the outer circumferential surface of the voice coil bobbin 9 at its upper edge part.

The edge 13 has an annular shape and an “Ω”-like sectional shape, and elastically supports the diaphragm 12. The inner circumferential edge part of the edge 13 is attached to the outer peripheral part of the diaphragm 12, and the outer circumferential edge part of the edge 13 is attached to the outer peripheral part of the supporting body 32.

(Configuration of Supporting Body)

The supporting body 32 has a substantially bowl shape, and supports the vibrating body 31 and the repulsive-type magnetic circuit 30. The supporting body 32 receives the repulsive-type magnetic circuit 30. At the part of the supporting body 32 confronting the under plate 1a of the yoke 1, there is provided an opening 32a for radiating the heat generated in the repulsive-type magnetic circuit 30 to the outside of the speaker device 100.

In the speaker device 100, the audio signals outputted by the pair of the output wires on the amplifier side are inputted to the voice coil 10 via the speaker terminals and further via the pair of plus/minus lead wires of the voice coil 10. By this, based on the Fleming's left-hand rule, an electromagnetic force (Lorentz force) acts on the voice coil 10 in the magnetic gap 33, and the diaphragm 12 moves together with the voice coil 10 in the acoustic radiation direction Y1 and its opposite direction to radiate the sound wave from the diaphragm 12 in the acoustic radiation direction Y1.

In the speaker device 100 having the configuration described above, the repulsive-type magnetic circuit 30 is characterized in that it includes the yoke 1, the pole piece 3 and the top plate 6, that the pole piece 3 is arranged above the yoke 1, that the top plate 6 is arranged above the pole piece 3, that the magnet 2 is arranged between the yoke 1 and the pole piece 3, and that the plural magnets 4 and 5 are arranged between the pole piece 3 and the top plate 6.

Now, assuming a speaker device of a comparative example including a repulsive-type magnetic circuit in which, not the plural magnets 4 and 5, but a single magnet is arranged between the pole piece 3 and the top plate 6 in the repulsive-type magnetic circuit 30, the voice coil 10 generates Joule heat when current is applied, and the Joule heat is propagated as the radiant heat to the pole piece 3, then each of to the plural magnets 4 and 5 as well as the magnet 2 arranged on the upper and lower sides of the pole piece 3, then further to the top plate 6 and the yoke 1. Thereby, the radiant heat propagated to the magnet 2 and the single magnet is radiated by the top plate 6 and the yoke 1.

However, if the voice coil 10 is driven for a long time in the comparative example, there is such a problem that the radiant heat is accumulated in each of the magnet 2 and the single magnet, the magnet 2 and the single magnet are demagnetized due to the accumulated heat (e.g., equal to or higher than 80 C.°, and hence the magnetic characteristic of those magnets are deteriorated. Particularly, in a case of using a rare earth magnet as the magnet 2 and the single magnet in the comparative example, the deficiency remarkably appears.

In this point, particularly in the repulsive-type magnetic circuit 30, the plural magnets 4 and 5 are arranged between the pole piece 3 and the top plate 6.

By arranging the plural magnets 4 and 5 in a divided manner between the pole piece 3 and the top plate 6, the radiant heat is hardly propagated to the magnet 5 arranged near the top plate 6, out of the plural magnets 4 and 5. Namely, in the repulsive-type magnetic circuit 30, the plural magnets 4 and 5 are arranged in the divided manner between the pole piece 3 and the top plate 6 so as to prevent that the magnetic characteristic of each of the plural magnets 4 and 5 arranged between the top plate 6 and the pole piece 3 are deteriorated by the radiant heat propagated via the pole piece 3.

As a result, when the voice coil 10 is driven for a long time, even if the radiant heat is continuously propagated to the pole piece 3, the temperature of the magnet 5 arranged on the top plate 6 side hardly rises. Thus, the demagnetization of the plural magnets 4 and 5 due to the temperature rise can be prevented, and the deterioration of the magnetic characteristic of the plural magnets 4 and 5 can be prevented. Further, even if the magnet 4 arranged on the pole piece 3 side is demagnetized due to the radiant heat and its magnetic characteristic is deteriorated, it is possible to minimize the deterioration of the magnetic characteristic of the plural magnets 4 and 5 arranged between the pole piece 3 and the top plate 6, as a whole. Furthermore, if there exists adhesive for jointing the plural magnets 4 and 5 between the plural magnets 4 and 5, it can be prevented that the radiant heat is propagated to the magnet 5 arranged on the top plate 6 side.

Similarly, by arranging the magnets 4 and 5 in a divided manner between the pole piece 3 and the yoke 1, it can be prevented that the radiant heat is propagated to the magnet 2 arranged on the yoke 1 side, as described above.

Also, the repulsive-type magnetic circuit 30 according to the embodiment is characterized in that the outside diameter d1 of the top plate 6 is smaller than the outside diameter d2 of the pole piece 3.

In the above comparative example, the direction of the magnetic flux near the top plate 6 is substantially opposite to the direction of the magnetic flux near the pole piece 3. Therefore, in view of magnetization, there is such a problem that large damping force acts on the vibration of the voice coil 10 and sufficient vibration cannot be obtained. Further, in the above comparative example, there is such a problem that the Joule heat generated by the voice coil 10 is propagated as the radiant heat to the top plate 6, then to the single magnet arranged on the lower side of the top plate 6, the temperature of the single magnet rises to demagnetize the single magnet, and the magnetic characteristic thereof is deteriorated.

In this point, in the repulsive-type magnetic circuit 30 according to the embodiment, since the outside diameter d1 of the top plate 6 is smaller than the outside diameter d2 of the pole piece 3, the damping force acting on the voice coil 10 can be diminished by the leak magnetic flux generated near the top plate 6 (the leak magnetic flux generated in a direction opposite to the direction of the magnetic flux generated near the pole piece 3). Therefore, the magnitude corresponding to the applied current can be given to the voice coil 10, and the diaphragm 12 can be largely vibrated.

In addition, since the outside diameter d1 of the top plate 6 is smaller than the outside diameter d2 of the pole piece 3, the distance between the voice coil 10 and the top plate 6 can be large. By separating the top plate 6 from the voice coil 10 in this manner, it can be prevented that the radiant heat is propagated to the top plate 6. Thereby, the temperature rise of the plural magnets 4 and 5 arranged on the lower side of the top plate 6 can be prevented. The demagnetization of the plural magnets 4 and 5 due to the temperature rise thereof can be prevented, and the deterioration of the magnetic characteristic of the plural magnets 4 and 5 can be prevented.

In addition, the repulsive-type magnetic circuit 30 according to the embodiment is characterized in that the yoke 1 includes the under plate 1a and the outer peripheral part 1b surrounding the under plate 1a; that the magnet 2, the pole piece 3, the plural magnets 4 and 5, and the top plate 6 are arranged on the under plate 1a in this order; and that the plate 7 is arranged on the upper surface 1ba of the outer peripheral part 1b of the yoke 1 separately from the yoke 1.

In the above comparative example, the magnetic flux is generated from the pole piece 3 to the yoke 1 (the magnetic flux is closed). In the area where the closed magnetic flux exists, there is a problem that the current distortion easily occurs. Also, in the comparative example, there is a problem that, since the Joule heat of the voice coil 10 is propagated as the radiant heat to the yoke 1, the temperature of the magnet arranged on the yoke rises, the magnet is demagnetized, and the magnetic characteristic is deteriorated. If the magnet exists on the lower side of the pole piece 3, the heat from the pole piece 3 is also propagated to the magnet to further raise the temperature of the magnet, the magnet is demagnetized, and the magnetic characteristic thereof is further deteriorated.

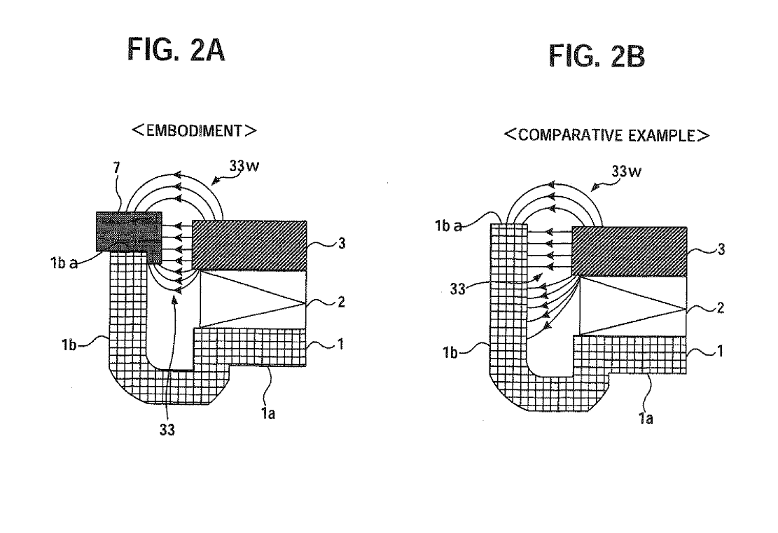

Now, it is assumed an another comparative example which is based on the configuration of the above-described comparative example and which includes a repulsive-type magnetic circuit 30x in which the outer peripheral part 1b of the yoke 1 has a cylindrical shape and the upper surface 1ba of the outer peripheral part 1b of the yoke 1 is substantially positioned at the same height as the upper surface of the pole piece 3. In that comparative example, as shown in FIG. 2B, the directions of the magnetic flux 33w on the upper side of the magnetic gap 33 (i.e., in the acoustic radiation direction Y1) and on the lower side of the magnetic gap 33 (i.e., in the direction opposite to the acoustic radiation direction Y1) are not symmetrical with each other. It is noted that the illustration of one magnet arranged on the pole piece 3 and the top plate arranged on the one magnet are omitted in FIG. 2B for the sake of convenience. Therefore, in this comparative example, there is such a problem that the vibration direction of the voice coil 10 is different through the magnetic gap 33 and abnormal vibration easily occurs. Further, in this comparative example, there is such a problem that, since the magnitude of the electromagnetic force (Lorentz force) acting on the voice coil 10 is different through the magnetic gap 33, desired magnitude of vibration cannot be obtained and good acoustic characteristic cannot be obtained.

In this point, in the repulsive-type magnetic circuit 30 according to the embodiment, the yoke 1 includes the under plate 1a and the outer peripheral part 1b surrounding the under plate 1a. The characteristic features are that the magnet 2, the pole piece 3, the plural magnets 4 and 5, and the top plate 6 are arranged on the under plate 1a in this order, and that the plate 7 formed separately from the yoke 1 and having a shape of extending (or projecting) inside (i.e., the center axis L1 side) from the inner wall of the outer peripheral part 1b of the yoke 1 is arranged on the upper surface 1ba of the outer peripheral part 1b of the yoke 1.

By dividing the yoke 1 into plural members (plate 7 and the yoke 1 itself), namely, into the plate 7 forming the magnetic gap 33 and the yoke 1 supporting the plate 7, an induced current can be generated in the plate 7. Therefore, the generation of the above-mentioned second magnetic flux can be prevented, and the generation of the current distortion in the speaker device 100 including the repulsive-type magnetic circuit 30 can be prevented.

Further, by arranging the plate 7 separated from the yoke 1 on the upper surface 1ba of the outer peripheral part 1b of the yoke 1, the radiant heat is hardly propagated from the plate 7 to the yoke 1. Thereby, the temperature rise of each of the plural magnets 4 and 5 arranged between the yoke 1 and the pole piece 3 can be prevented. As a result, it can be prevented that each of the plural magnets 4 and 5 is demagnetized due to the temperature rise of the plural magnets 4 and 5, and hence it can be prevented that the magnetic characteristic of the plural magnets 4 and 5 are deteriorated.

Further, with this configuration, as shown in FIG. 2A, by extending the plate 7 from the inner peripheral part of the yoke 1 to the pole piece 3, the directions of the magnetic flux 33w on the upper side of the magnetic gap 33 (i.e., in the acoustic radiation direction Y1) and on the lower side of the magnetic gap 33 (i.e., in the direction opposite to the acoustic radiation direction Y1) become substantially symmetrical with each other. Therefore, the vibration direction and vibration magnitude of the voice coil 10 as well as the driving force acting on the voice coil 10 become substantially symmetrical through the magnetic gap 33, and hence the abnormal vibration as well as the deterioration of the vibration and the acoustic characteristic can be prevented. Further, by increasing the thickness of the plate 7 or extending the inner peripheral part of the plate 7 toward the bottom part of the yoke 1, the area in which the magnetic flux acts on the voice coil 10, i.e., the width of the magnetic gap 33 (the width of the vibration body 31 in the vibration direction side) becomes large even if the voice coil 10 largely vibrates. Thus, the driving force of the repulsive-type magnetic circuit 30 becomes constant irrespective of the magnitude, and the distortion of the reproduced sound can be diminished. Also, by this, the contact of the constitutional element of the vibration body 31 with the repulsive-type magnetic circuit 30 can be prevented. FIG. 2A is a main-part sectional view of the repulsive-type magnetic circuit 30 according to the embodiment, and illustration of the plural magnets 4 and 5 arranged on the pole piece 3 and top plate 6 arranged on the magnet 5 are omitted for the sake of convenience.

Further, the repulsive-type magnetic circuit 30 according to the embodiment is characterized in that the height d3 from the bottom of the yoke 1 to the upper surface of the plate 7 is higher than the height d4 from the bottom of the yoke 1 to the upper surface of the pole piece 3.

By making the height d3 from the bottom of the yoke 1 to the upper surface of the plate 7 higher than the height d4 from the bottom of the yoke 1 to the upper surface of the pole piece 3 as described above, the distance between the plate 7 and the top plate 6 can be reduced. By positioning the plate 7 closer to the top plate 6 in this way, Permeance Coefficient (a value obtained by dividing the magnetic flux density by the magnetic flux) can be large. Therefore, the operation point of the plural magnets 4 and 5 arranged between the top plate 6 and the pole piece 3 can be large. Meanwhile, there is a measure of making the magnets 4 and 5 thicker in order to make the operation point of the plural magnets 4 and 5 large. However, there is a demerit that the magnetic flux density in the magnetic gap 33 does not become so large if the thickness of the plural magnets 4 and 5 is increased. Therefore, the measure of positioning the plate 7 closer to the top plate 6 is more preferable than the measure of making the plural magnets 4 and 5 thicker, because the magnetic flux density of the magnetic gap 33 can be further increased.

Further, the repulsive-type magnetic circuit 30 according to the embodiment is characterized in that each of the plural magnets 4 and 5 includes at least a ferrite magnet and a rare earth magnet.

In this configuration, if the magnetic characteristic of the rare earth magnet constituting each of the plural magnets 4 and 5 is deteriorated due to the accumulation of the radiant heat, the deterioration of the magnetic characteristic of the plural magnets 4 and 5 as a whole is smaller in comparison with the case in which the whole of the plural magnets 4 and 5 is a rare earth magnet. Therefore, the deterioration of the acoustic characteristic of the speaker device 100 can be minimized.

### Modified Example-1

In the above-described comparative example, when the current is applied to the voice coil 10, the magnetic flux from the top plate 6 to the pole piece 3 (referred to as “second magnetic flux”) is generated by the current. There is such a problem that the current distortion easily occurs in the area where the second magnetic flux is generated.

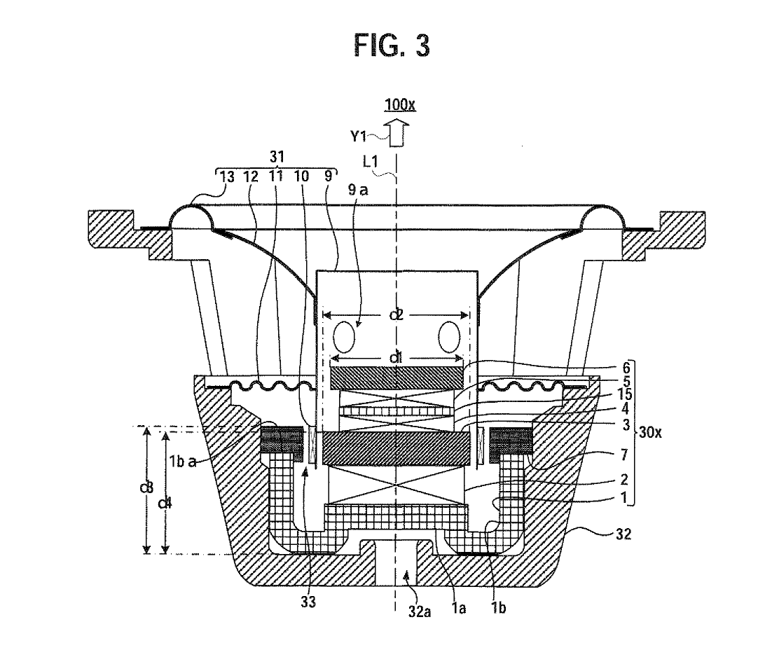

Therefore, in the modified embodiment-1 of the invention, the above problem is solved by arranging a metal layer 15 between the plural magnets 4 and 5 in the repulsive-type magnetic circuit 30x as shown in FIG. 3 corresponding to FIG. 1.

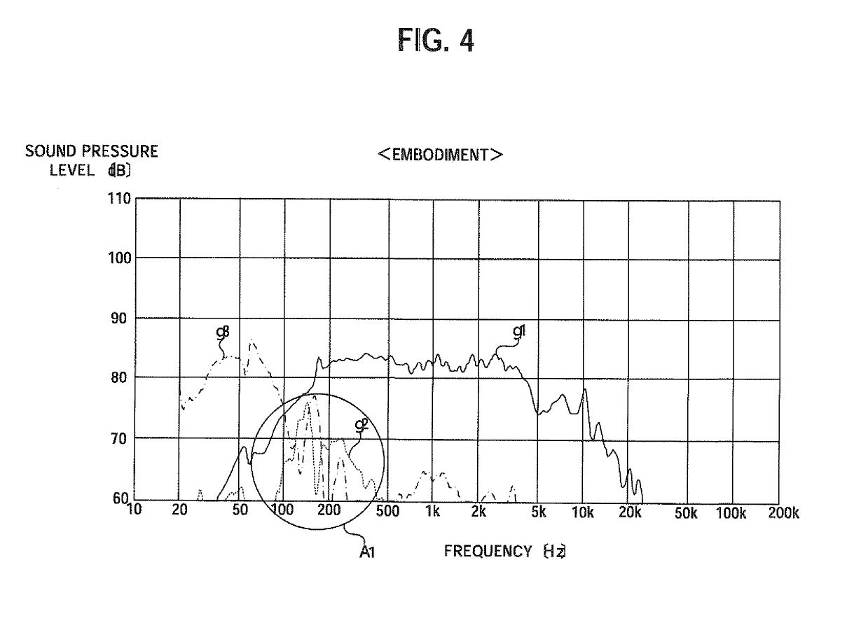

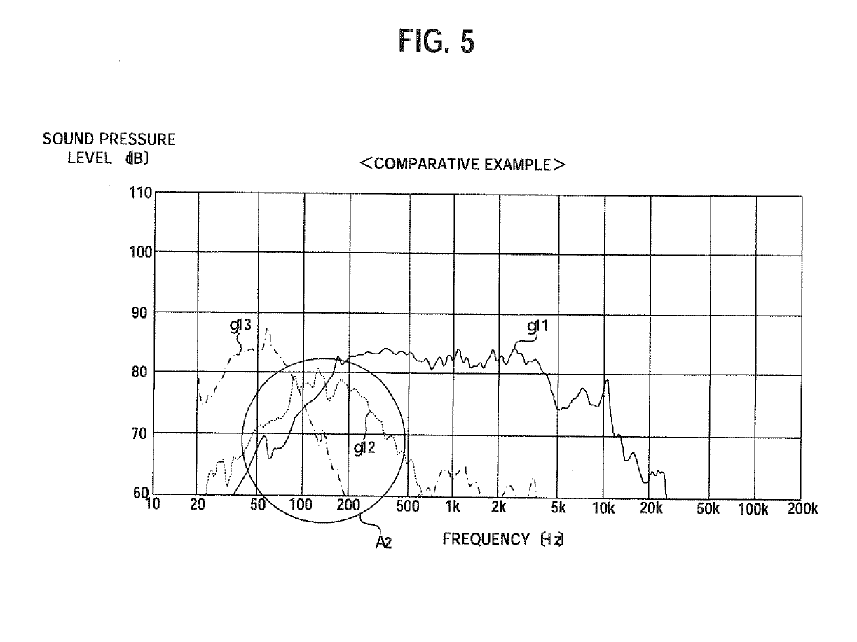

FIG. 4 is a graph showing the relation between the sound pressure level [dB] of the speaker device 100x using the repulsive-type magnetic circuit 30x and the frequency [Hz]. In FIG. 4, the graph g1 of solid line shows the frequency characteristic of the speaker device 100x, the graph g2 of broken line shows the second harmonic distortion of the speaker device 100x, and the graph g3 of dashed line shows the third harmonic distortion of the speaker device 100x, respectively. It is noted that the second harmonic distortion and the third harmonic distortion are illustrated after adding 30 [dB] to the sound pressure level. Further, FIG. 5 shows the relation between the sound pressure level [dB] of the speaker device (not shown) using the repulsive-type magnetic circuit according to the comparative example, which includes, not the plural magnets 4 and 5, but the single magnet on the pole piece 3 in the repulsive-type magnetic circuit 30x, and the frequency [Hz]. In FIG. 5, the graph g11 of solid line shows the frequency characteristic of the speaker device according to this comparative example, the graph g12 of broken line shows the second harmonic distortion of the speaker device according to this comparative example, and the graph g13 of dashed line shows the third harmonic distortion of the speaker device according to this comparative example, respectively.

As understood by comparing the second harmonic distortion of the speaker device 100x according to the modified example-1 (particularly, the part of the area A1 in FIG. 4) with the second harmonic distortion of the speaker device according to this comparative example (particularly, the part of the area A2 in FIG. 5), the second harmonic distortion of the speaker device 100x according to the modified example-1 is smaller than the second harmonic distortion of the speaker device according to this comparative example. By this, an induced current is generated in the metal layer 15, and it can be prevented that the voice coil 10 in which the current flows generates the current distortion in the repulsive-type magnetic circuit 30x.

In a preferred example, it is preferred that at least one of the materials forming the metal layer 15 has a thermal conductivity larger than that of the magnet 2 (or the magnet 4 and 5). Also, it is preferred that at least one of the materials forming the metal layer 15 has an electric conductivity larger than that of the magnet 2 (or the magnet 4 and 5). In this way, by making the at least one material forming the metal layer 15 arranged between the magnet 4 and 5 a layer of material (including alloy), such as aluminum, nickel, etc., having large thermal conductivity or large electric conductivity, the generation of the induced current is enhanced. By the generation of the induced current, it can be prevented that the current distortion occurs in the repulsive-type magnetic circuit 30x. However, it is required that the metal layer 15 is appropriately thin so that it does not obstruct the passage of the magnetic flux between the plural magnets 4 and 5. Therefore, it is preferred that the thickness of the metal layer 15 is approximately 15 μm, for example.

### Modified Example-2

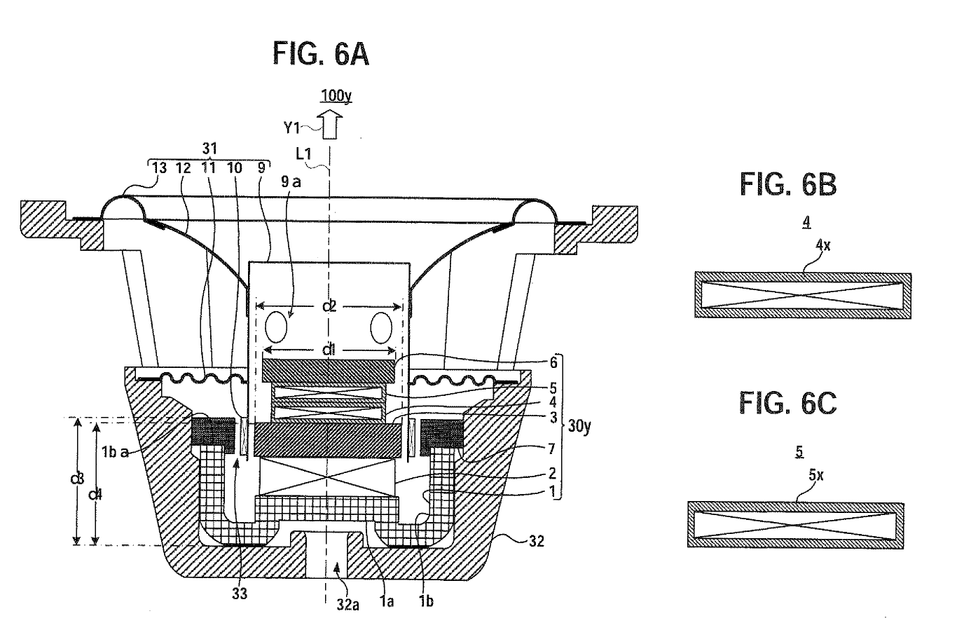

Further, in the present invention, the problem suggested by the modified example-1 may be solved by the modified example-2, instead of the modified example-1, in which metal layers 4x and 5x are formed on the surface of the plural magnets 4 and 5 in the repulsive-type magnetic circuit 30y as shown in FIGS. 6A to 6C. FIG. 6A is a sectional view of the speaker device 100y including the repulsive-type magnetic circuit 30y according to the modified example-2 corresponding to FIG. 1, and FIGS. 6B and 6C show the sectional views of the magnets 4 and 5 constituting the repulsive-type magnetic circuit 30y.

In a preferred example, it is preferred that the metal layers 4x and 5x are formed by the constitutional material similar to the metal layer 15. Also, it is required that the metal layers 4x and 5x are appropriately thin so that it does not obstruct the passage of the magnetic flux between the plural magnets 4 and 5. Therefore, it is preferred that the thickness of the metal layers 4x and 5x is approximately 15 μm, for example. By this, similar to the modified example-1, the second harmonic distortion (not shown) of the speaker device 100y according to the modified example-2 is smaller than the second harmonic distortion of the speaker device according to the comparative example in the modified example-1. Thereby, an induced current is generated in the metal layers 4x and 5x, and it can be prevented that the voice coil 10 in which the current flows generates the current distortion in the repulsive-type magnetic circuit 30y.

Particularly, by forming the metal layers 4x and 5x at the external surface of the magnets 4 and 5, the thermal conductivity becomes large at the surface of the magnets 4 and 5, and the heat accumulation in the plural magnets 4 and 5 can be prevented. Further, since many heat paths are formed from the pole piece 3 to the top plate 6, the path is long and the surface area of the repulsive-type magnetic circuit 30y contacting the outside becomes large, the heat is easily radiated as the above-mentioned radiant heat, and the temperature of the repulsive-type magnetic circuit 30y hardly rises. In addition, since the pole piece 3 and the top plate 6 are thermally connected to each other, there are such advantages that the heat propagation from the pole piece 3 to the plural magnets 4 and 5 can be prevented, that the heat can be easily propagated to the top plate 6 and that the heat can be easily radiated from the top plate 6 as the radiant heat.

In the above-described modified example-2, the metal layers 4x and 5x are formed on the surface of the plural magnets 4 and 5, respectively. However, the present invention is not limited to this example. In order to obtain the advantages of the above-mentioned modified example-2, the metal layer may be formed on the surface of the magnet 4 or the magnet 5, out of the plural magnets 4 and 5.

### Other Modified Example

In the embodiment, the modified example-1 and the modified example-2 described above, one magnet 2 is provided between the under plate 1a of the yoke 1 and the pole piece 3. However, the present invention is not limited to this, and a plurality of magnets may be provided between the under plate 1a of the yoke 1 and the pole piece 3.

By providing a plurality of magnets in a divided manner between the under plate 1a of the yoke 1 and the pole piece 3, it can be prevented that temperature of the plurality of magnets arranged between the under plate 1a of the yoke 1 and the pole piece 3 rises due to the radiant heat propagated via the pole piece 3. As a result, the demagnetization of the plurality of magnets due to the temperature rise of those magnets can be prevented, and the deterioration of the magnetic characteristic of each of the plurality of magnets can be prevented.

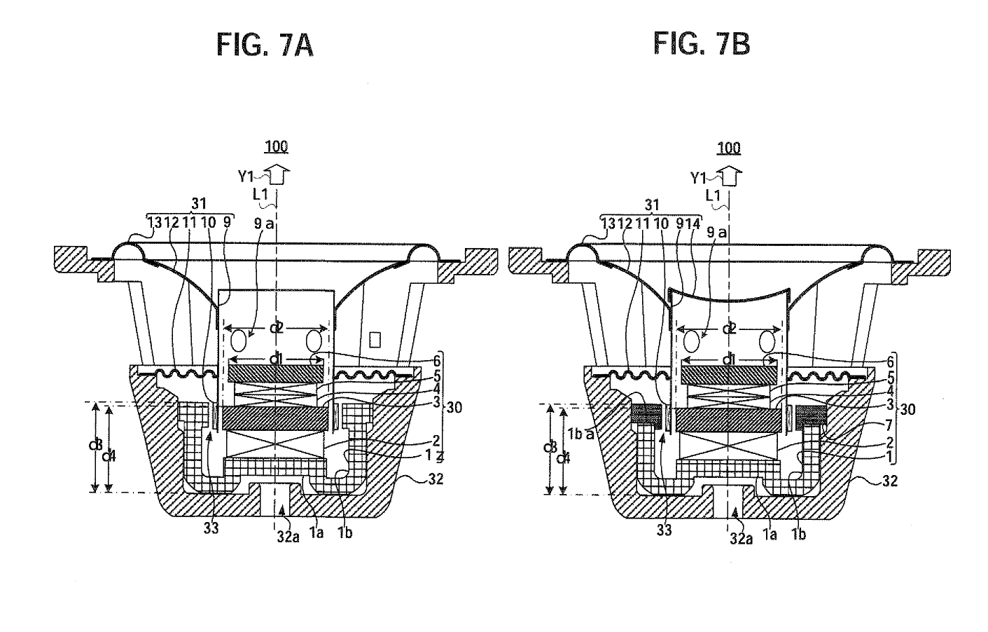

Further, although the plate 7 is provided on the upper surface 1ba of the outer peripheral part 1b of the yoke 1 in the embodiment and the modified examples-1 and -2 described above, the yoke 1 and the plate 7 may be integrally formed (corresponding to the yoke 1z) as shown in FIG. 7A corresponding to FIG. 1. It is sufficient that the outer peripheral part 1b of the yoke 1 has a shape of extending toward the pole piece 3.

Further, although the vibration body 31 includes the voice coil bobbin 9, the voice coil 10, the damper 11, the diaphragm 12 and the edge 13 as the constitutional elements in the embodiment and the modified examples-1 and -2 described above, the vibration body 31 may further include a center cap 14, as necessary, as shown in FIG. 7B corresponding to FIG. 1.

Further, the present invention may variously modified within a range not deviating from its gist.

### INDUSTRIAL APPLICABILITY

This invention can be used for a repulsive-type magnetic circuit for various speaker device which is used at home, installed in a mobile equipment or installed on a vehicle.

1-12. (canceled)

13. A repulsive-type magnetic circuit comprising:
a first magnet and a second magnet including plural magnets arranged such that same poles of the first magnet and each of the plural magnets as the second magnet confront each other; a yoke; a pole piece; and a top plate,
wherein the pole piece is arranged above the yoke,
wherein the top plate is arranged above the pole piece,
wherein the first magnet is arranged between the yoke and the pole piece, and
wherein the second magnet is arranged between the pole piece and the top plate.

14. The repulsive-type magnetic circuit according to claim 13, wherein a metal layer is arranged between the plural magnets as the second magnet.

15. The repulsive-type magnetic circuit according to claim 14, wherein at least one material forming the metal layer has a thermal conductivity larger than that of the first magnet or the second magnet.

16. The repulsive-type magnetic circuit according to claim 14, wherein at least one material forming the metal layer has an electric conductivity larger than that of the first magnet or the second magnet.

17. The repulsive-type magnetic circuit according to claim 13, wherein a metal layer is formed on a surface of at least one of the plural magnets as the second magnet.

18. The repulsive-type magnetic circuit according to claim 13, wherein an outside diameter of the top plate is smaller than an outside diameter of the pole piece.

19. The repulsive-type magnetic circuit according to claim 13,
wherein the yoke includes: an under plate; and an outer peripheral part surrounding the under plate,
wherein the first magnet, the pole piece, the second magnet and the top plate are arranged on the under plate in this order, and
wherein a plate is arranged on the outer peripheral part of the yoke.

20. The repulsive-type magnetic circuit according to claim 19, wherein a height from a bottom of the yoke to the upper surface of the plate is higher than a height from the bottom of the yoke to an upper surface of the pole piece.

21. The repulsive-type magnetic circuit according to claim 20, wherein the plate extends toward the pole piece from an inner circumferential part of the yoke.

22. The repulsive-type magnetic circuit according to claim 13, wherein the second magnet includes at least a ferrite magnet and a rare earth magnet.

23. The repulsive-type magnetic circuit according to claim 13, wherein the first magnet includes a plurality of magnets provided between the yoke and the pole piece.

24. A speaker device comprising:
the repulsive-type magnetic circuit according to claim 13;
a frame which supports the repulsive-type magnetic circuit; and
a vibrating body supported by the frame,
wherein the vibrating body includes a diaphragm; an edge which supports the diaphragm to the frame; a voice coil bobbin around which a voice coil supported by the diaphragm is wound; and a damper which supports the voice coil to the frame.

25. A repulsive-type magnetic circuit comprising:
a first magnet and a second magnet including plural magnets arranged such that same poles of the first magnet and each of the plural magnets as the second magnet confront each other; a yoke; a pole piece; and a top plate,
wherein the pole piece is arranged above the yoke,
wherein the top plate is arranged above the pole piece,
wherein the second magnet is arranged between the yoke and the pole piece, and
wherein the first magnet is arranged between the pole piece and the top plate.

26. The repulsive-type magnetic circuit according to claim 25, wherein a metal layer is arranged between the plural magnets as the second magnet.

27. The repulsive-type magnetic circuit according to claim 26, wherein at least one material forming the metal layer has a thermal conductivity larger than that of the first magnet or the second magnet.

28. The repulsive-type magnetic circuit according to claim 26, wherein at least one material forming the metal layer has an electric conductivity larger than that of the first magnet or the second magnet.

29. The repulsive-type magnetic circuit according to claim 13,
wherein the yoke includes: an under plate of disc shape which supports the first magnet or the second magnet; an outer peripheral part of cylindrical shape which surrounds the under plate; and a curving part which has a curving sectional shape extending in a direction toward the yoke from the first magnet and which is provided between the under plate and the outer peripheral part,
wherein the plate is arranged on the outer peripheral part and is formed by a member separated by the yoke,
wherein an upper surface of the plate is higher than an upper surface of the pole piece.

30. The repulsive-type magnetic circuit according to claim 29,
wherein an upper surface of the outer peripheral part of the yoke supporting the plate is positioned at a height between an lower surface and an upper surface of the pole piece, and
wherein a part of the plate extending from the outer peripheral part of the yoke toward the pole piece includes a lower edge part which is positioned substantially at same height as the lower surface of the pole piece and which covers an inside of the outer peripheral part of the yoke.

31. The repulsive-type magnetic circuit according to claim 30, wherein an outside diameter of the top plate is smaller than an outside diameter of the pole piece.

32. A speaker device comprising:
the repulsive-type magnetic circuit according to claim 31;
a frame which supports the repulsive-type magnetic circuit; and
a vibrating body supported by the frame,
wherein the vibrating body includes a diaphragm; an edge which supports the diaphragm to the frame; a voice coil bobbin around which a voice coil supported by the diaphragm is wound; and a damper which supports the voice coil to the frame, and
wherein an edge part of a part of the plate extending from the outer peripheral part of the yoke toward frame is positioned adjacent to the frame.

33. An automobile comprising the speaker device according to claim 24.
